(19) United States
(12) Patent Application Publication
(10) Pub. No.: US 2023/0125177 A1
(43) Pub. Date: Apr. 27, 2023

(54) METHODS AND SYSTEMS FOR MATCHING AND OPTIMIZING TECHNOLOGY SOLUTIONS TO REQUESTED ENTERPRISE PRODUCTS

(71) Applicant: FINTECH NEXT LTD., Tel Aviv (IL)

(72) Inventors: Avi COHEN, Tel Aviv (IL); Gil DEVORA, Tel Aviv (IL); Yaron BUZNACH, Ganei Tikvah (IL)

(21) Appl. No.: 18/008,210

(22) PCT Filed: Jun. 10, 2021
(86) PCT No.: PCT/IB2021/055095

§ 371 Date: Dec. 5, 2022

Related U.S. Application Data
(60) Provisional application No. 63/037,040, filed on Jun. 10, 2020.

(51) Int. Cl. G06Q 10/0637; G06Q 30/0201; G06F 16/31

(52) U.S. Cl. CPC G06Q 10/0637; G06Q 30/0201; G06F 16/313

(57) ABSTRACT

A method for matching and optimizing technology solutions to requested product solutions, including: generating a repository of product features by extracting the product features from a given set of products; generating a repository of technology solutions by extracting the technology solutions from existing technology packages respectively supporting each of the products of the set of products; associating the technology solutions with the product features; and training a challenge interpretation engine to: interpret a submitted challenge for a new product; generate, based on the submitted challenge as interpreted, a set of the product features selected from the repository of product features, the set of product features to comprise the new product; and generate a set of technology solutions by selecting the technology solutions associated with the product features in the set of product features for the new product the set of technical solutions forming a basis for a new technology package.

### FIELD OF THE INVENTION

The present invention relates to technology solution for enterprise products and, more specifically, to automatically generating a repository of technological solutions for requested enterprise products.

### BACKGROUND OF THE INVENTION

Many enterprises today rely heavily on technological solutions for their products. For an enterprise to remain relevant and competitive it is necessary to introduce new products and update old ones. This is especially true of large enterprises with multiple products.

For example, one of the main concerns of banks today is the need to keep up with the rising number of new regulations, market disruptors and customers' demand for new, innovative services. The stakes are high when implementing or upgrading a solution within the bank's ecosystem. This is true of many service and manufacture industries such as insurance companies, healthcare providers, appliance manufacturers, teaching institutions, etc. etc.

With traditional business models being challenged all the time, combined with complex regulation environments, banks are forced to find ways to operate in an uncertain regulatory environment, while new technological entrants are challenging the industry.

While on the other side, process updates are not up to speed with market demand and may lead to elongated timelines and excessive costs. Banks committed to innovation, competitiveness and profitability must overcome the very real consequences of integrating new technology solutions.

### SUMMARY OF THE INVENTION

The presented invention was designed to provide the enterprises with methods and tools for identifying and optimizing the required technology solutions needed for keeping enterprises technologically relevant and competitive, while reducing risks, expenses and time to market.

According to the present invention there is provided a method for matching and optimizing technology solutions to requested product solutions, the method including the steps of: generating a repository of product features by extracting the product features from a given set of products; generating a repository of technology solutions by extracting the technology solutions from existing technology packages respectively supporting each of the products of the set of products; associating the technology solutions with the product features; and training a challenge interpretation engine to: (i) interpret a submitted challenge for a new product, (ii) generate, based on the submitted challenge as interpreted, a set of the product features selected from the repository of product features, the set of product features to comprise the new product; and (iii) generate a set of technology solutions by selecting the technology solutions associated with the product features in the set of product features for the new product the set of technical solutions forming a basis for a new technology package.

According to further features in preferred embodiments of the invention described below the challenge interpretation engine is further configured to: (iv) optimize the set of technology solutions to provide a minimum optimized set, the minimum optimized set including a minimum number of the technology solutions from the set of technical solutions that overlap with a maximum number of the product features from the set of product features.

According to still further features in the described preferred embodiments each of the technology solutions is supplied by one of a plurality of vendors and wherein the challenge interpretation engine is further configured to: (iv) optimize the set of technology solutions to provide a minimum optimized set, the minimum optimized set including a maximum number of the product features from a minimum number of the plurality of vendors.

According to further features the challenge interpretation engine includes a machine learning classification model trained on descriptors of the product features in the repository of product features.

According to further features the submitted challenges are submitted in a format selected from the group including: text-based submissions, unstructured free text submissions, audio submissions interpreted by voice recognition software, voice-to-text submission. According to further features each of the product features extracted from the given set of products is normalized prior to being added to the repository of product features.

According to further features the extracting the product features includes: (i) performing data extraction on at least one data source that includes a description of each of the products, the data extraction providing extracted text; (ii) running a classifier on the extracted text to classify portions of the extracted text into the product features.

According to further features the repository of product features includes for each of the product features: an identifier of the product feature, an associated the technology solution and a vendor name.

According to further features the extracting the product features further includes: (iii) extracting from the extracted text, by the classifier, a name of one of the technology solutions for each of the product solutions classified by the classifier.

According to further features a technology engine is configured for extracting the technology solutions from the technology packages. According to further features the technology engine extracts the technology solutions from descriptive data of the technology packages. According to further features the technology engine extracts code segments of the technology solutions from the technology packages.

According to further features artificial intelligence or machine learning is employed for associating the technology solutions with corresponding the product features and storing the associations in a Product Features to Technology Solutions Repository.

According to another embodiment there is provided a method for matching and optimizing technology solutions to requested product solutions, the method comprising: generating a repository of product features by extracting the product features from products of a similar type; generating a repository of technology solutions by extracting the technology solutions from existing technology packages respectively supporting each of the products; associating the technology solutions with the product features; and training a challenge interpretation engine to: (i) interpret a submitted challenge for a new product, (ii) generate, based on the submitted challenge as interpreted, a set of the product features selected from the repository of product features, the set of product features to comprise the new product; and (iii) generate a set of technology solutions by selecting the technology solutions associated with the product features in the set of product features for the new product the set of technical solutions forming a basis for a new technology package.

According to further features a technology engine is configured for extracting the technology solutions from the existing technology packages.

### BRIEF DESCRIPTION OF THE DRAWINGS

Various embodiments are herein described, by way of example only, with reference to the accompanying drawings, wherein:

FIG. 1 is a high-level schematic description of a “Product” which is broken down into its corresponding “Product Features”;

FIG. 2 is a high-level schematic description of a “Technology Solution”, which is broken down into its corresponding “Product Features”;

FIG. 3 is a high-level schematic description of the relations between “Products”, “Product Features” and “Technology Solutions”;

FIG. 4 is a high-level block diagram which describes the process of breaking down multiple “Products” into their corresponding normalized “Product Features” and storing them as a distinct collection in a “Product Features Repository”;

FIG. 5 is a high-level block diagram that describes the process of associating “Product Features” to “Technology Solutions” that are taken from the distinct collection of “Product Features” stored in the “Product Features Repository”;

FIG. 6 is a high-level block diagram that describes the process of interpreting a “Business/Enterprise Challenge” to a single or a set of “Product Features” followed by a “Matching & Optimization” process;

FIG. 7 is a high-level block diagram that describes a process for creating a Dataset and a machine learning model for interpreting Business Challenges to “Product Features”;

FIG. 8 is a high-level block diagram that describes a process for updating the Product Features to Technology Solutions Repository;

FIG. 9 is a high-level block diagram that describes a process for creating a Dataset and a machine learning model for interpreting Description text of Product Feature to Bank “Product Features”.

### DESCRIPTION OF THE PREFERRED EMBODIMENTS

By way of introduction, the instant method and system is a new way for enterprises to develop products which are based on technological solutions. The method and system can be applied to many areas and industries. One such industry has been selected as an example that will be used extensively throughout this document. It is made clear that the extensive use of a single subject matter is merely for the sake of clarity, continuity, and depth. By no way is the use of a single example intended to be limiting in any way, fashion, or form.

The instant innovation generally includes the following stages:

Stage 1—reduce each enterprise Product to its composite Product Features.

Stage 2—reduce each known Technology Solution to its composite Product Features.

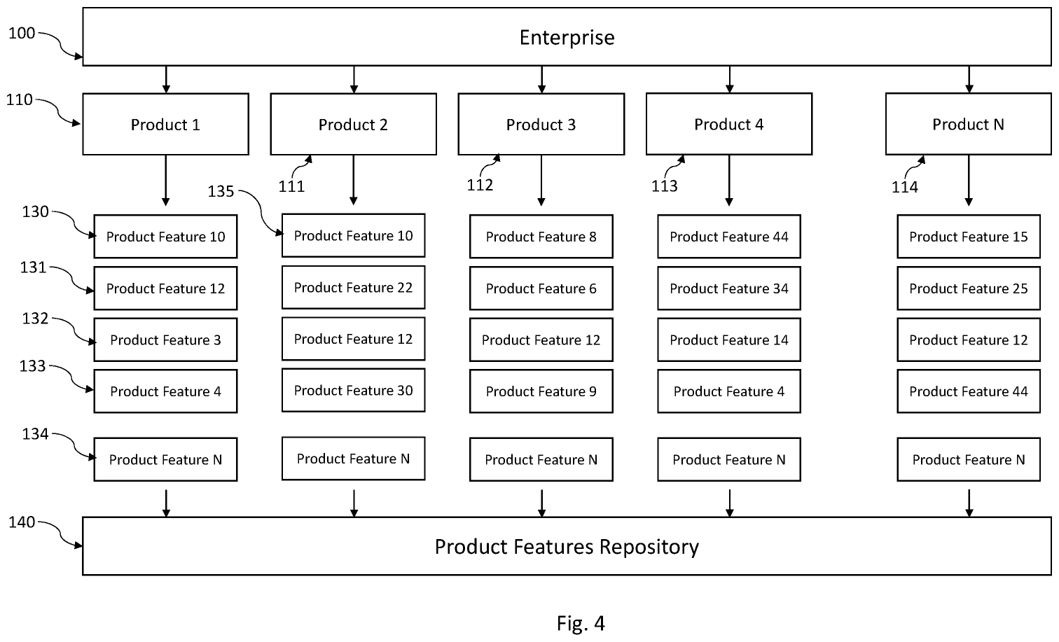

Stage 3—create a Repository of Product Features for a given set of products (see FIG. 4).

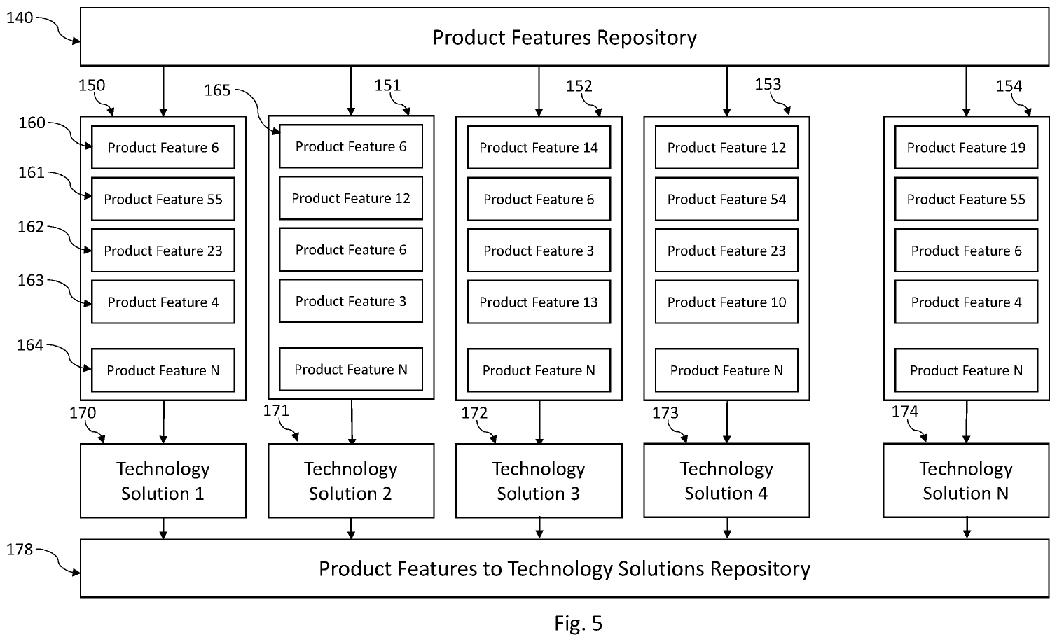

Stage 4—create a Product Features to Technology Solutions Repository (see FIG. 5).

Stage 5—provide a “Machine Learning/Manual process of Challenge Interpretation” process that “Interprets” a “Business/Enterprise challenge” (e.g., given as unstructured free text) and returns a single/set of “Product Features” that make up the Challenge (i.e., all the product features needed to do what the enterprise challenge is trying to do).

Stage 6—Perform a “Matching & Optimization” process that matches and optimizes a single or a set of “Technology Solution/s” that support all the returned “Product Feature/s” from Stage 5.

The “Matching & Optimization” includes 2 steps:

(1) Selecting “Technology Solution/s” by finding matching “Product Features”; and

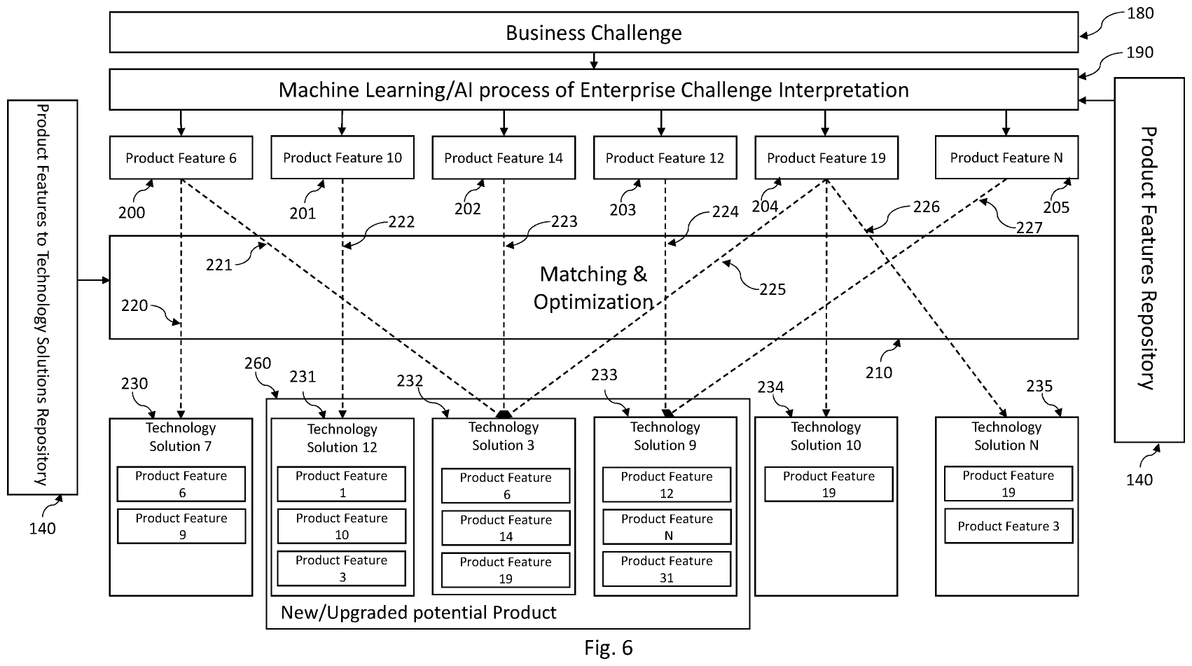

(2) In case the selecting stage resulted in more than one “Technology Solution”, optimizing the selected “Technology Solutions” to minimum optimized set (See FIG. 6).

Certain terms and phrases are used herein which are intended to convey particular meanings or concepts. Some of these phrases are discussed briefly hereafter. While an attempt is being made to define these phrases, it is to be recognized that the entirety of the document is to be taken into consideration when forming a cohesive understanding of the phrases.

The term “product” is a general term that is being used herein to refer to a product or service that employs a technical solution in order to provide that product. A product may be a computer game, an online portal for an insurance company/social security/online banking, etc., a heath provider application, an online shopping app/interface, etc., etc. The list is virtually endless. A product may be an entire entity or maybe a part, module, node, aspect, etc. of a service or industry offering. For example in a banking enterprise the term “Product” relates to a service/product that is offered to customers, such as “credit cards”, “mortgages”, “loans”, “insurance”, etc.

“Product Feature”—A characteristic that describes a “Product's” appearance, component, capability, security measure and/or business functionality that has a corresponding benefit or set of benefits for the end customer. A “Product” may have any number of “Product Features”.

According to the present innovation, as in many cases, different “Products” may share the same “Product Feature/s” (due to the need to comply with the same mandatory internal and external regulations, meet the same hard security standards of the given enterprise, the need to potentially be integrated with other “Products” and/or business processes, etc.) Accordingly, the names of the “Product Features” must be distinct and normalized (use the exact same names and terminology) across all “Products”.

“Technological/Technology Solution”—A single piece, or integrated set, of software and/or hardware which is/are used to implement a single “Product” and its corresponding “Product Features”. “Product Feature” names are distinct and normalized across all “Technology Solutions”. Technology solutions are provided by vendors. One vendor can provide many technology solutions. Many technology solutions have unique names. Some of the unique names identify the solution with a brand and/or vendor.

“Technology Solution Use-Case” aka “Use Case”—Define a specific case of the “Technology Solution” usage and/or how the “Technology Solution” may be used for different scenario.

“Technology package” is a suite of one or more technology solutions that provide the technical aspect of a product.

According to the present innovation, the terms “Use Case” and “Product Features” are normalized and point to the same meaning and therefore, from now on, the term “Product Features” will be used instead of “Use Case”.

“Enterprise/Business Challenge”—An opportunity, requirement, and/or request for a new product or improvement to an already existing “Product” that is typically resolved by creating a new “Product” or by upgrading an existing “Product”. An Enterprise/Business Challenge may be presented as a detailed, free, unstructured text, e.g. “I am looking to extend credit to our retail customers in the US.”

The principles and operation of method and system for procuring new and updated product based on technological solutions according to the present invention may be better understood with reference to the drawings and the accompanying description.

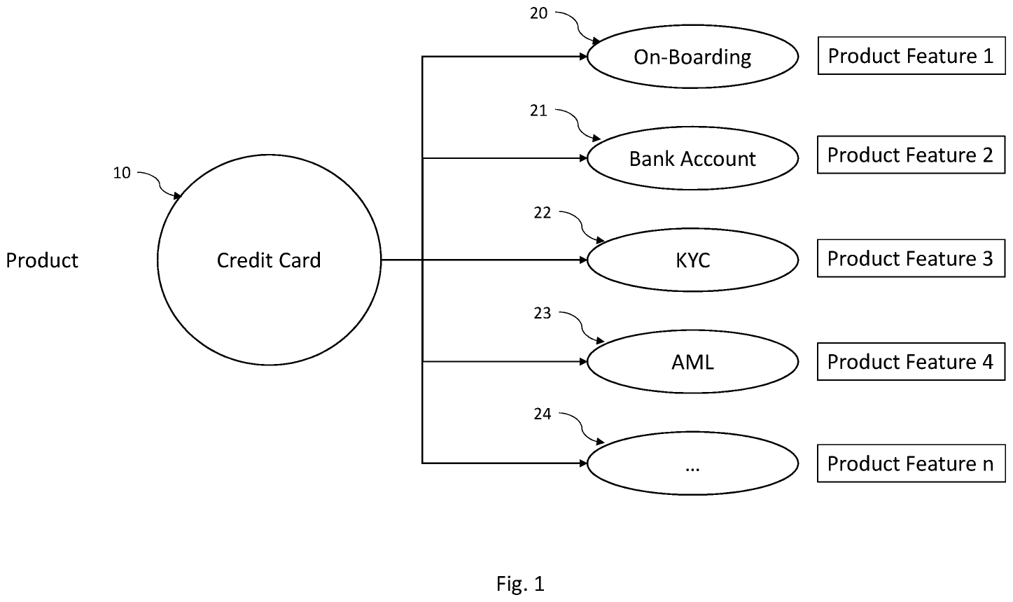

FIG. 1 shows a high-level schematic description of a “Product” which is broken down into its corresponding “Product Features”. Block 10 represents a “Product” (e.g., “Credit Card”). Each product includes or is made up of one or more product features. Block 20 represents “Product Feature 1”. In the banking example of a product being a credit card, one of the product features is “On Boarding”. On boarding is a process that allows a customer of the to join the “Credit Card” services product). Blocks 20-24 represent various exemplary product features. Block 21 is “Product Feature 2”, e.g. “Bank Account” (the actual bank account that holds the customer's money that will be used to pay for actual Credit-Card usage), Block 22 is “Product Feature 3”, e.g. “KYC”, Know Your Customer (a mandatory regulatory process that verifies the Bank customer identity), Block 23 is “Product Feature 4”, e.g. “AML” Anti Money Laundering (a mandatory regulatory process that verifies and monitors that the Bank customer is not involved in a criminal act of Money Laundering) and Block 24 “Product Feature n”, represent any other potential “Product Features”. “Product” 10 may have any number of corresponding “Product Features”.

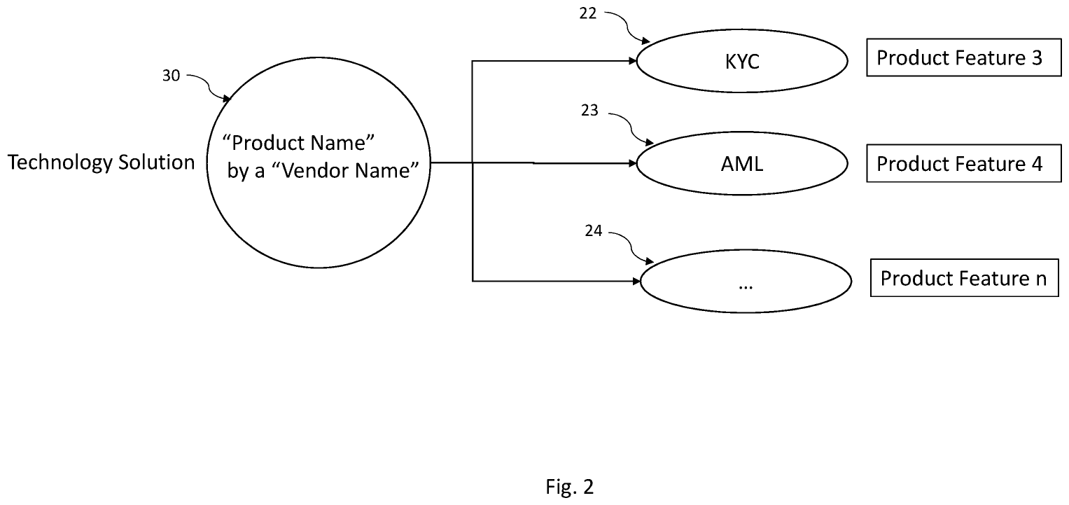

FIG. 2 shows a high-level schematic description of a “Technology Solution”, which is broken down into its corresponding “Product Features” in a very similar way a “Product” is broken down to “Product Features,” as described in FIG. 1.

Block 30 represents a technological solution or “Technology Solution”. The solution is developed by some Vendor. The name of the technological solution as well as the “Vendor Name” are important pieces of information. In the example, one vendor has a technological/technology solution that addresses three product features: Block 22 “Product Feature 3”, e.g. “KYC”, block 23 “Product Feature 4”, e.g. “AML” and Block 24 “Product Feature n”, any potential “Product Feature”.

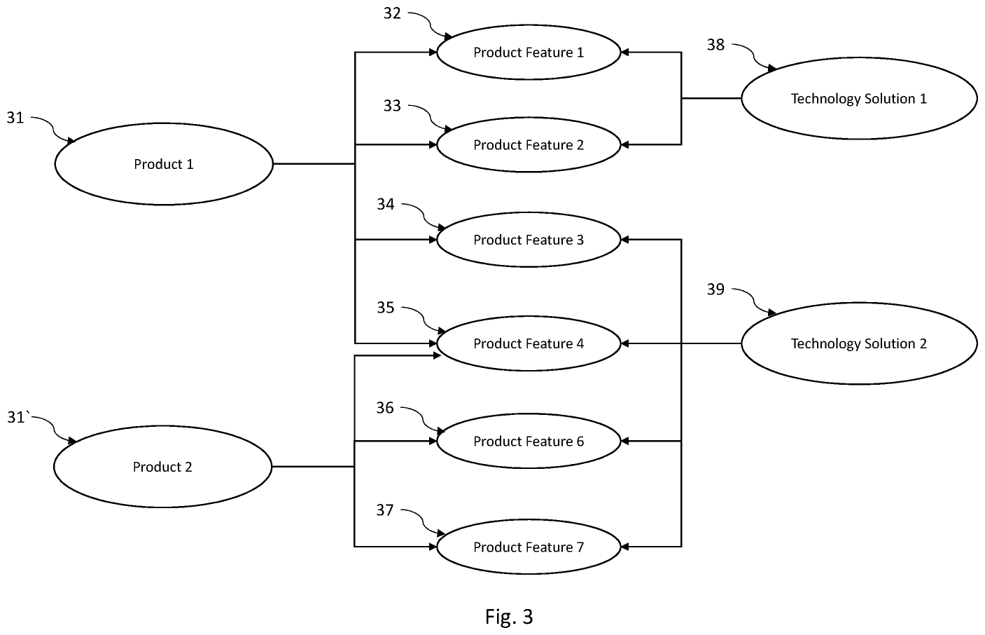

FIG. 3 shows a high-level schematic description of the relations between “Products”, “Product Features” and “Technology Solutions”.

Block 31 represents an enterprise product designated “Product 1”, which is associated to “Product Feature 1” 32, “Product Feature 2” 33, “Product Feature 3” 34 and “Product Feature 4” 35. Block 31′ represents a second enterprise product designated “Product 2”, which is associated to “Product Feature 7” 37, “Product Feature 6” 36 and “Product Feature 4” 34, that is associated in parallel to “Product 1” 30, which is possible as “Products”, according to this innovation, may share “Product Features”. Block 38 represents “Technology Solution 1”, which is associated to “Product Feature 1” 32 and “Product Feature 2” 33. Block 39 represents “Technology Solution 2”, which is associated to “Product Feature 3” 34, “Product Feature 7” 37, “Product Feature 6” 36 and “Product Feature 4” 34.

According to this innovation, “Products” and “Technology Solutions” correspond with each other through “Product Features” and therefore, “Products” may (partly or fully) be implemented by a “Technology Solution”. For example: “Product 2” 31 may be fully implemented by “Technology Solution 2” 39, while “Product 1” 30 may be fully implemented by both “Technology Solution 1” 38 and “Technology Solution 2” 39. Alternatively, it can be claimed that “Product 1” 30 may be partly implemented by “Technology Solution 1” 38.

FIG. 4 shows a high-level block diagram which describes the process of breaking down multiple “Products” into their corresponding normalized “Product Features” and storing them as a distinct collection in a “Product Features Repository”.

Block 100 represents a typical enterprise such as a bank or an insurance company. Blocks 110 (“Product 1”), 111 (“Product 2”), 112 (“Product 3”), 113 (“Product 4”) and 114 (“Product n”) represent an array of “Products”. Each “Product” is associated to its corresponding “Product Features”. For example, “Product 1” 110 is associated with “Product Features 10” 130, “Product Features 12” 131, “Product Features 3” 132, “Product Features 4” 133, “Product Features N” 134.

According to this invention, “Product Feature” names are distinct and normalized across all “Products”, for example: blocks 130 and 135 represent the same “Product Feature 10”, which is associated in parallel to two different “Products”, “Product 1” 110 and “Product 2” 111.

In preferred embodiments, an automated “bot” scans the descriptive literature related to the products to extract descriptive data regarding the products. The descriptive data (text, audio and/or audio-visual) may be stored digitally in some location such as on an internal system (network/server) of the company (enterprise), or on the company's website or on one or more websites that are not under the control of the company. Descriptive literature may exist in paper form which can be scanned, and the scanned documents subjected to Optical Character Recognition (OCR) to render the hard copies into digital format to allow the bot or web crawler to gather the data.

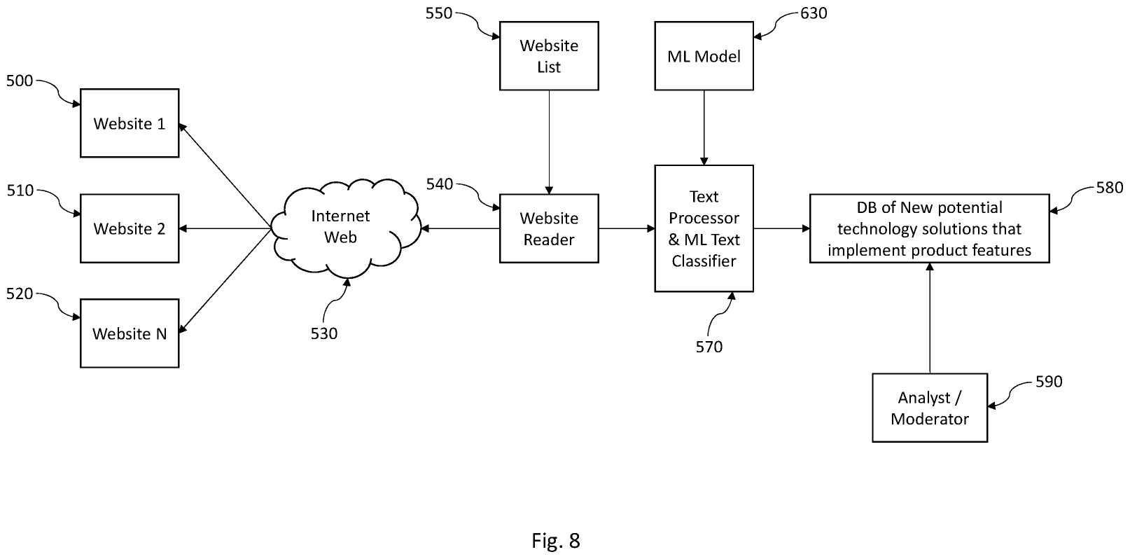

A Text Processor and Machine Language (ML) Text Classifier can parse the data and identify distinct product features that comprise the product. Text parsing using Natural Language Processing (NLP) methods and processing of the text with an ML text classifier is discussed at greater length in relation to FIG. 8 and applies mutatis mutandis here as well. NLP also extracts the name of the technological solution from within the text that describes what the solution does vis-à-vis the product feature.

Block 140 represents a “Product Features Repository”, which stores a distinct collection of all normalized “Product Features” (that were stored as a result of the process of breaking down/extracting from multiple “Products” into corresponding “Product Features”). An identifier of the product feature is stored in the repository. The identifier may be a description of the product feature, a normalized name of the product feature and/or any other type of identifier.

FIG. 5 shows a high-level block diagram that describes the process of associating “Product Features” to “Technology Solutions” that are taken from the distinct collection of “Product Features” stored in the “Product Features Repository”.

Block 140 represents a “Product Features Repository”, which stores a distinct collection of all normalized “Product Features”. Blocks 170 (“Technology Solution 1”), 171 (“Technology Solution 2”), 172 (“Technology Solution 3”), 173 (“Technology Solution 4”) and 174 (“Technology Solution n”) represent “Technology Solutions”. Each “Technology Solution” is associated with its corresponding “Product Features”. For example, “Technology Solution 1” 170 is associated with “Product Feature 6” 160, “Product Feature 55” 161, “Product Feature 23” 162, “Product Feature 4” 163, “Product Feature N” 164.

According to this invention, “Product Feature” names are distinct and normalized across all “Technology Solutions”, for example: blocks 160 and 165 represent the same “Product Feature 6”, which is associated in parallel to two different “Technology Solutions”, “Technology Solution 1” 170 and “Technology Solution 2” 171.

In preferred embodiments, a “technology engine” sniffs out segments of code that pertain to the technological solutions. In some embodiments the engine parses the code and runs recognition software (AI/ML) on the code that recognizes segments of the code that are indicative of specific technology solutions. For example, based on corresponding keywords in the technology solutions and the product features the AI/ML engine compares different products that include the same product features and the same technical solutions to understand which solutions support which product features.

In a more detailed example, both the banking industry and the insurance industry have to comply with government regulation. To this end, all the banking and insurance institution providing the same services also have to adhere to the same regulations. However, each institution develops their own technological solution such that different institutions/platforms provide different technological solutions for the same product features (e.g., to abide by a particular regulation). The AI/ML engine can access and scan the technological packages and identify different solutions that support the same product features by comparing the similar functions that each technology solution needs to provide (i.e., functions that are learned from understanding/learning the product features, as discussed elsewhere herein).

An alternative or additional method can be a text-based method. Many institutions outsource the creation of technology solutions to technology vendors. Vendors may provide one or more technology solutions for one or more product features of a given product that the institution commissions the vendor for. Vendors may even provide technology solutions for an entire product. Vendors give technology solutions names for the purpose of product (i.e., the technology solution) recognition and even brand/vendor recognition. Institutions that acquire and implement these technology solutions include the names of the solutions in their descriptive data describing their own products supported by these technology solutions. The technology engine of the instant system can employ bots and/or web crawlers to extract the descriptive data from various parallel institutions in the same industry. The descriptive data is parsed and processed by the technology engine to extract product features, descriptions of the product features and technology solution names of the technology solutions supporting the product features.

In the Figure, Block 178 represents “Product Features to Technology Solutions Repository” that serves as a repository for the “Technology Solutions” with their corresponding “Product Feature/s”. The repository may store product features (i.e., the normalized terms for the same product features, seeing as each institution or vendor may use slightly different terms to label the same product features), descriptions and the corresponding technology solution (in the form of actual code segments or technology solution names) as well as the vendor name. E.g., each of these data for each project feature may be recorded in distinct fields/records in a single row.

FIG. 6 shows a high-level block diagram that describes the process of interpreting a “Business/Enterprise Challenge” to a single or a set of “Product Features” followed by a “Matching & Optimization” process, which results with a single or a set of “Technology Solution/s”, that potentially may implement a “Product”. It is noted that the “Matching & Optimization” process which is included in this description is just an example for this process and any “Matching & Optimization” process may be implemented instead.

Block 180 represents a “Business/Enterprise Challenge”, that may be given as a detailed free unstructured text. An example of a “Business/Enterprise Challenge” unstructured text may be “I am looking to extend credit to our retail customers in the US.”

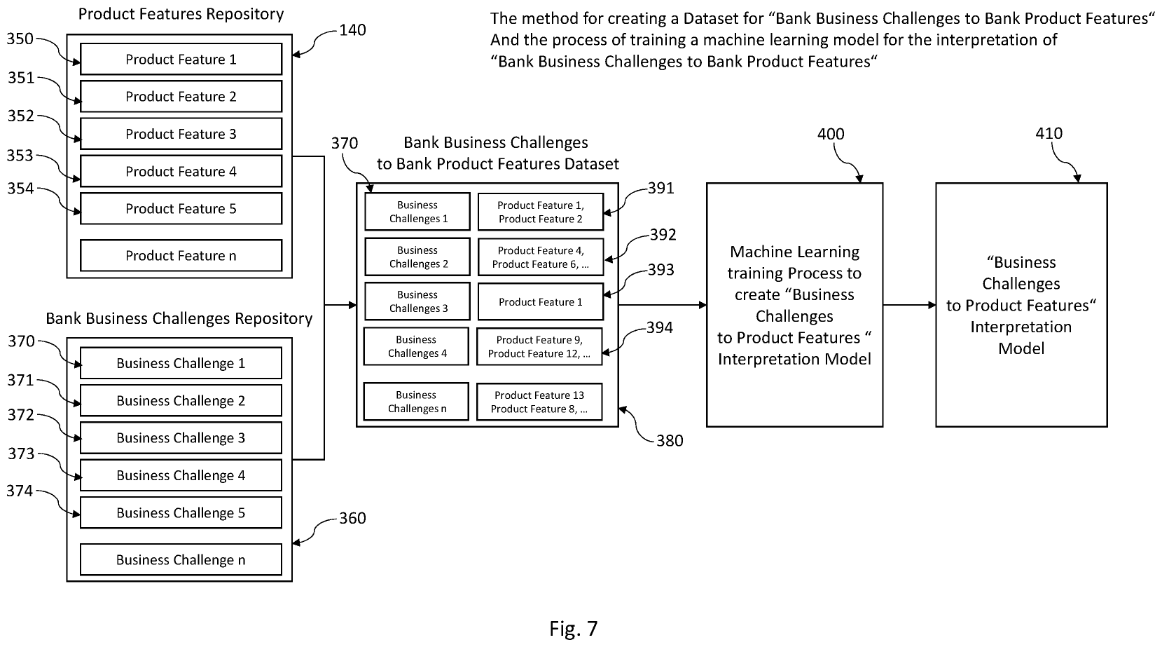

Block 190 represents a “Machine Learning/Manual process of Challenge Interpretation” process that “Interprets” a “Business/Enterprise challenge” 180, given as unstructured free text, to a single or a set of “Product Features”. The “Interpretation” process may be implemented as: (1) A manual process, which is typically done by a banking business expert person and a baking product expert who know exactly which “Product Features” need to be implemented in order to resolve the “Business/Enterprise Challenge”. The “Product Features” may be taken only from the “Product Features Repository” 140; (2) A machine learning classification model that was trained to automatically execute the process done in (the above) point 1 (will be elaborated in FIG. 7).

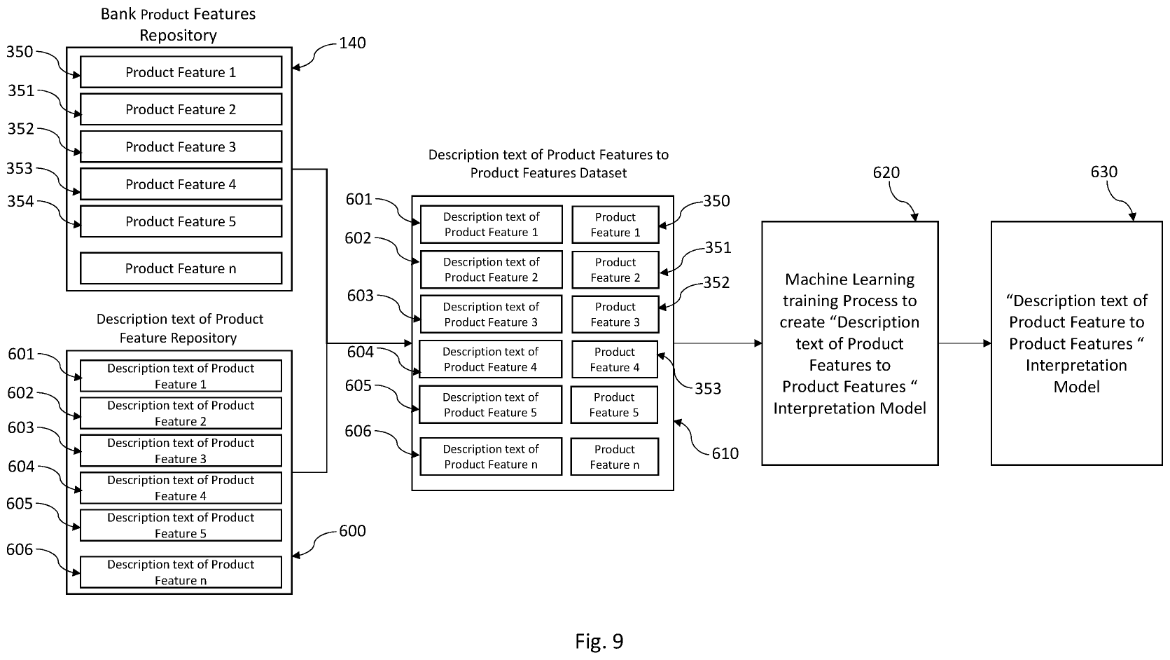

According to other embodiments, discussed with relations to FIGS. 8 and 9, the product features and/or product solutions may be taken from outside the institution/enterprise. For example, the bots, classifiers, processors and technology engine may be directed alternatively or additionally outwards of the enterprise systems/network in order to search for products, product features and/or technology solutions from other enterprises and/or vendors (usually of a similar type, e.g., in the same industry). The methods and systems apply mutatis mutandis whether the product features and/or technology solutions come from within the company/enterprise, from outside the enterprise, or from a combination of the two.

Blocks 200 (“Product Feature 6”, e.g. “On-Boarding”), 201 (“Product Feature 10”, e.g. “Bank Account”), 202 (“Product Feature 14”, e.g. “Know Your Customer”), 203 (“Product Feature 12”, e.g. “AML”), 204 (“Product Feature 19”, e.g. “Multi-Factor Authentication”) and 205 (“Product Feature 6”, e.g. Any potential “Product Feature”) represents “Product Features” that were outputted from the “Machine Learning/AI process of Enterprise Challenge Interpretation” 190 process.

Block 210 represents a “Matching & Optimization” process that matches and optimizes a single or a set of “Technology Solution/s” that include “Product Feature/s”, which are overlapping with the “Product Feature/s” that were resulted from the “Machine Learning/AI process of Enterprise Challenge Interpretation” 190 process. The “Matching & Optimization” 210 may be performed by an optimization module according to various methods. One exemplary method consists of a one or two-step process as follows: (1) Selecting “Technology Solution/s” by finding matching “Product Features”; and (2) In case the selecting stage resulted in more than one “Technology Solution”, optimizing the selected “Technology Solutions” to minimum optimized set.

Illustration of “step 1”: “Product Feature 6” 200 is included in “Technology Solution 7” 230 as well as “Technology Solution 3” 232. Therefore “Technology Solution 7” and “Technology Solution 3” will be selected. While the process continues, it is noted that “Product Feature 10” is included only in “Technology Solution 12” 231 and therefore “Technology Solution 12” will be selected as well. The process will continue until all “Technology Solutions” that include at least one of “Product Features 6/10/14/12/19/N” will be selected.

Illustration of “step 2”: The aim of this step is to select minimum “Technology Solutions” which overlap maximum “Product Features” that resulted from “step 1”. As shown in this Figure: “Technology Solution 3” 232, “Technology Solution 12” 231 and “Technology Solution 9” 233 include “Product Features” that overlapped with all “Product Features” resulted from “step 1”, and therefore represent the minimum set of “Technology Solutions” that may be “packaged” to a “New/Upgraded potential Product” 260. Note that “Technology Solution 7” 230, “Technology Solution 10” 234 and “Technology Solution N” 235 are not included in the minimum set as they include “Product Features” that already included in the minimum set.

It is important to have an optimization module for optimizing the use of resources for creating a new product. One manner of optimization is to use the most product features from the least number of vendors. Contracting a single vendor or minimum number of vendors is the best use of many resources (money, time, vendor relations (human and computer), etc.). Accordingly, the optimization module may be configured to optimize the set of technology solutions to provide a minimum optimized set in which the maximum number of product features/technology solutions are provided by a minimum number of vendors.

FIG. 7 shows a high-level block diagram that describes a process for creating a Dataset and a machine learning model for interpreting Business Challenges to “Product Features”. It is noted that the described process is an example and may be implemented in many alternative ways.

Block 140 represents a “Product Features Repository” that includes all available “Product Features” (as described in detail in FIG. 4). Blocks 350, 351, 352, 353 and 354 represent “Product Features” which are available from the “Product Features Repository” 140. Block 360 represents “Business Challenges Repository” that include a collection of detailed text descriptions of “Business Challenges” (370, 371, 372, 373 and 374).

Block 380 represents “Business/Enterprise Challenges to Product Features Dataset”, which includes “Business Challenges” that are associated to corresponding single or a collection of “Product Features”. For example, “Business Challenge 1” 370 is associated to a Collection 391 that includes “Product Feature 1” 350 and “Product Feature 2” 351. The collection 391 may include any number of “Product Features”. The process of associating a “Business Challenge” to “Product feature/s” may be performed using AI and/or by a ML engine trained on existing descriptive data and associated product features from within the enterprise environment or even from external sources.

Block 400 represents a Machine Learning training process to create “Business Challenges to Product Features” Interpretation Model. For this purpose, any machine learning methodology known in the art can be used. For example, Neural Network Machine Learning methodology for multi or single label/s text classification. Block 410 represents “Business Challenges to Product Features” Interpretation Model. This Model may be used as part of the process described in FIG. 6, Block 190 “Machine Learning/AI process of Challenge Interpretation”.

Example of a Bank business challenge—Note this example is related to the process explained in relation to FIG. 6.

The following example is selected from the banking industry and may be employed by a specific institution. A UI/GUI is provided for submitting the challenge. There may be many initial parameters to define prior to submitting the challenge in order to focus the system to the correct field and services. One example of a focus parameter is providing the filed within the enterprise/industry.

The parameter is “Bank challenge field” and the information provided is “Digital transformation for Factoring products”.

The challenge may be presented in free-form writing, such as:

“We need to identify solutions capable of transforming and digitizing the Customer Journey experience of the current Supply Chain Finance product range, with a focus on Confirming & Dynamic Discounting:
Digital customer journey that enables a frictionless process (i.e., digital contracts and signature, buyer & supplier profiling on the platform, invoice loading, payments & management, . . . );
Digital on-boarding (i.e., remote identification, digital signature, . . . );
Open architecture for dialogue with Supply Chain Finance products and services platforms (Confirming & Dynamic discounting);
Algorithms/simulators for dynamic/flexible pricing, etc.;
The solution must be able to guarantee a high level of technological maturity;
The solution must include high level of innovation;
The solution must support different languages.”

The Proposed Patent Analysis Flow:

The detected bank “product features” base on the unstructured text of the given “Bank business challenge”. This is done using the trained machine learning mode, but for this specific illustration the reference text sections are included:

| | Text reference for the |
|---|---|
| Detected Product feature | “Bank business challenge” |
| Digital Customer Journey | “digital contracts and signature” |
| | “invoice loading” |
| | “payment & management” |
| Digital On-boarding | “remote identification” |
| | “digital signature” |
| Dynamic Pricing | “dynamic/flexible pricing” |

The technology solution and vendor detected for each “product feature”:

| | Detected Vendor | |
|---|---|---|
| | with solution that | |
| | implements the | Relevant Solution(s) |
| Detected | detected product | by Vendor for the |
| Product feature | feature | detected product feature |
| Digital | Easysend | EasySign |
| Customer Journey | Reach | REACH Closing, |
| Digital | Au10tix | identity-verification |
| On-boarding | | document verification |
| | Reach | REACH Engagement |
| | Scanovate | Advanced Identity Management |
| | | and Onboarding Toolkit |
| | Easysend | EasySign |
| Dynamic Pricing | Earnix | Price-It (Analytical Pricing) |

Optimization:

Based on the results, it is evident that the solution “EasySign” by vendor “Easysend”, covers two product features: “Digital Customer Journey” and “Digital On-boarding” and therefore will be recommended for these product features, while the solution “Price-It (Analytical Pricing)” by vendor “Earnix”, covers the product feature “Dynamic Pricing” and therefore will be recommended for this product feature.

FIG. 8 shows a high-level block diagram that describes a process for updating the Product Features to Technology Solutions Repository 178. Block 550 represents a database of a web site address of technology solution vendors that potentially may include technology solutions that can implement product features. The list may be created by a human technology expert in the technology solution industry or automatically extracted from any data source or using any other method.

Web scraping, web harvesting, or web data extraction is data scraping used for extracting data from websites. The web scraping software may directly access the World Wide Web using the Hypertext Transfer Protocol or a web browser. While web scraping can be done manually by a software user, the term typically refers to automated processes implemented using a bot or web crawler. It is a form of copying in which specific data is gathered and copied from the web, typically into a central local database or spreadsheet, for later retrieval or analysis. Block 540 represents a web reader (e.g., a bot or web crawler), which may be a software module/program code that receives a website address from the website list 550 and fetches the entire text of the given website.

Block 630 represents a Machine Learning model that has been taught (and continues to learn) to classify text into product features, e.g., recognizing a text as mapping back to a previously known product feature or even a new, heretofore unknown product feature. This Block will be elaborated on in detail with relation to FIG. 9.

Block 570 represents a Text Processor & ML Text Classifier, which receives text that is extracted from a website by the website reader 540. Exemplarily, the classifier may use Natural Language Processing methods that are known in the art on the extracted text to process the text and cut the text into paragraphs, which the classifier then attempts to classify into product features using the Machine Learning Model 560. NLP also extracts the name of the vendor that has created the solution as well as the name of the technological solution from within the text that describes what the solution does. If a corresponding product feature is detected in the text, then the corresponding text, the name of the Vendor, the name of the technology solution and the relevant product feature are placed in a database of new potential technology solutions that implement product features 580.

Block 590 represents the function of an Analyst/Moderator, who is tasked with, inter alia, reviewing the results in the database of new potential technology solutions that implement product features 580. Reviewing the results includes, at least, correcting or removing bad results and assigning the proper technology solution name from the extracted text.

FIG. 9 shows a high-level block diagram that describes a process for creating a Dataset and a machine learning model for interpreting Description text of Product Feature to Bank “Product Features”. It is noted that the described process is an example and may be implemented in many alternative ways.

Block 140 represents a “Bank Product Features Repository” that includes all available Bank “Product Features” (as described in detail in FIG. 4). Blocks 350, 351, 352, 353 and 354 represent Bank “Product Features” which are available from the “Bank Product Features Repository” 140. Block 600 represents “Description text of Product Features Repository” that includes a collection of detailed text descriptions of Product Features (601, 602, 603, 604, 605 and 606).

Block 610 represents “Description text of Product Features to Product Features Dataset”, which includes “Description text of Product Features” that are associated to corresponding single or a collection of “Product Features”.

Block 620 represents a Machine Learning training process to create “Description text of Product Features to Product Features” Interpretation Model. For this purpose, any machine learning methodology known in the art can be used. For example, Neural Network Machine Learning methodology for multi or single label/s text classification. Block 630 represents “Description text of Product Features to Product Features Dataset” Interpretation Model. This Model may be used as part of the process described in FIG. 8.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for matching and optimizing technology solutions to requested product solutions, the method comprising steps of:
generating a repository of product features by extracting said product features from a given set of products;
generating a repository of technology solutions by extracting said technology solutions from existing technology packages respectively supporting each of said products of said set of products;
associating said technology solutions with said product features; and
training a challenge interpretation engine to:
(i) interpret a submitted challenge for a new product,
(ii) generate, based on said submitted challenge as interpreted, a set of said product features selected from said repository of product features, said set of product features to comprise said new product; and
(iii) generate a set of technology solutions by selecting said technology solutions associated with said product features in said set of product features for said new product said set of technical solutions forming a basis for a new technology package.

2. The method of claim 1, wherein said challenge interpretation engine is further configured to:
(iv) optimize said set of technology solutions to provide a minimum optimized set, said minimum optimized set including a minimum number of said technology solutions from said set of technical solutions that overlap with a maximum number of said product features from said set of product features.

3. The method of claim 1, wherein each of said technology solutions is supplied by one of a plurality of vendors and wherein said challenge interpretation engine is further configured to:
(iv) optimize said set of technology solutions to provide a minimum optimized set, said minimum optimized set including a maximum number of said product features from a minimum number of said plurality of vendors.

4. The method of claim 1, wherein said challenge interpretation engine includes a machine learning classification model trained on descriptors of said product features in said repository of product features.

5. The method of claim 1, wherein said submitted challenges are submitted in a format selected from the group including: text-based submissions, unstructured free text submissions, audio submissions interpreted by voice recognition software, voice-to-text submission.

6. The method of claim 1, wherein each of said product features extracted from said given set of products is normalized prior to being added to said repository of product features.

7. The method of claim 1, wherein said extracting said product features includes:
(i) performing data extraction on at least one data source that includes a description of each of said products, said data extraction providing extracted text;
(ii) running a classifier on said extracted text to classify portions of said extracted text into said product features.

8. The method of claim 7, wherein said repository of product features includes for each of said product features: an identifier of said product feature, an associated said technology solution and a vendor name.

9. The method of claim 7, wherein said extracting said product features further includes:
(iii) extracting from said extracted text, by said classifier, a name of one of said technology solutions for each of said product solutions classified by said classifier.

10. The method of claim 1, wherein a technology engine is configured for extracting said technology solutions from said technology packages.

11. The method of claim 10, wherein said technology engine extracts said technology solutions from descriptive data of said technology packages.

12. The method of claim 10, wherein said technology engine extracts code segments of said technology solutions from said technology packages.

13. The method of claim 10, wherein artificial intelligence or machine learning is employed for associating said technology solutions with corresponding said product features and storing said associations in a Product Features to Technology Solutions Repository.

14. A method for matching and optimizing technology solutions to requested product solutions, the method comprising:
generating a repository of product features by extracting said product features from products of a similar type;
generating a repository of technology solutions by extracting said technology solutions from existing technology packages respectively supporting each of said products;
associating said technology solutions with said product features; and
training a challenge interpretation engine to:
(i) interpret a submitted challenge for a new product,
(ii) generate, based on said submitted challenge as interpreted, a set of said product features selected from said repository of product features, said set of product features to comprise said new product; and
(iii) generate a set of technology solutions by selecting said technology solutions associated with said product features in said set of product features for said new product said set of technical solutions forming a basis for a new technology package.

15. The method of claim 14, wherein a technology engine is configured for extracting said technology solutions from said existing technology packages.
